(19) United States
(12) Patent Application Publication
(10) Pub. No.: US 2005/0154720 A1
(43) Pub. Date: Jul. 14, 2005

(54) Destination search device and destination search method

(76) Inventors: Takeshi Kurosawa, Iwaki-city (JP); Hideyuki Takishita, Iwaki-city (JP)

Correspondence Address: BRINKS HOFER GILSON & LIONE, P.O. BOX 10395, CHICAGO, IL, 60610, US

(21) Appl. No.: 10/987,315

(22) Filed: Nov. 12, 2004

(30) Foreign Application Priority Data
Nov. 27, 2003 (JP) 2003-396821

(51) Int. Cl. G06F 7/00; G06F 17/30

(52) U.S. Cl. 707/3

(57) ABSTRACT

For a plurality of points of interest associated with each other, a plurality of pieces of point of interest name data representing names of points of interest is stored in association with a single piece of telephone number data. When a telephone number is entered, a plurality of pieces of point of interest name data is displayed so as to be selectable.

### BACKGROUND

1. Field of the Invention

The present invention relates to destination search devices and destination search methods in navigation apparatuses or the like, and more particularly, to a destination search device and a destination search method capable of searching for position data of a destination by entering a telephone number.

2. Description of the Related Art

In general, navigation apparatuses detect the current position of a vehicle using a self-contained navigation sensor, a global positioning system (GPS) receiver, or the like, and read map data around the position from a recording medium to be displayed on a screen. A vehicle position mark indicating the current position of the vehicle is displayed in a superimposed manner in a predetermined position on the screen, so that a user can immediately know the position of the vehicle while traveling.

Recently, most navigation apparatuses have been provided with a route guidance function to allow drivers to easily travel to a desired destination without taking a wrong road. Such a route guidance function automatically searches for a route from the current position to the destination that has the lowest cost using map data, and renders the found route as an emphasized guidance route such that the color of the route is different from other roads on the map screen. Also, when the vehicle approaches a range limit of a predetermined distance from an intersection on the guidance route, predetermined information on the intersection is provided, so that drivers are guided to the destination.

Here, the term “destination” includes a final destination where a driver desires to go and a transit point between the current position and the final destination. Also, the term “cost” refers to a value obtained by quantifying the degree of appropriateness of a guidance route. The cost can be obtained, based on a distance, by multiplying predetermined constants corresponding to a road width, a road type (for example, ordinary road or expressway), right turn or left turn, traffic conditions, and the like. If there are two routes having the same distance, the cost changes depending on the designation of search conditions, such as whether or not a driver will use an expressway, or whether time is priority or distance is priority. In route search processing, points where a plurality of roads cross, such as intersections and crossroads, are referred to as nodes, and vectors connecting adjoining nodes are referred to as links. Link costs on various routes from the current position to the destination are sequentially added, and a route whose total link cost is lowest is selected as a guidance route.

In-vehicle navigation apparatuses of this type normally have some destination setting methods. For example, a known method for searching for a particular point by entering a telephone number (hereinafter, referred to as telephone number data) is disclosed in, for example, Japanese Unexamined Patent Application Publication No. 2-187898. In an in-vehicle navigation apparatus according to Japanese Unexamined Patent Application Publication No. 2-187898, if entered telephone number data is not recorded in a storage device, a representative point corresponding to office number data (an area code and a local office number of the telephone number) of the telephone number data is searched for, and map data centering on the representative point is displayed. Accordingly, a point on the map is set.

In the known in-vehicle navigation apparatuses, however, a telephone number is associated with only a single point of interest (POI). Thus, for POIs that are associated with each other and are located in a plurality of locations, unless a user knows a telephone number of a desired POI, even if the user knows a POI that is associated with the desired POI, the desired POI cannot be searched for as a destination. For example, if a telephone number of a reservation center located in Tokyo is used for making a reservation for a hotel located in Fukushima, the desired hotel located in Fukushima cannot be searched for as a destination using the telephone number.

### BRIEF SUMMARY

In order to solve the above problems, an object of the present invention is that when a destination is searched for using telephone number data, a point of interest that is associated with a point of interest corresponding to the entered telephone number data can be searched for as a destination.

In order to achieve the above object, according to the present invention, for points of interest that are associated with each other, a single piece of telephone number data is associated with a plurality of pieces of point of interest name data and a plurality of pieces of position data, and the plurality of pieces of point of interest name data corresponding to the entered single piece of telephone number data is displayed so as to be selectable.

According to the present invention, a desired point of interest can be selected as a destination from among a plurality of points of interest including a point of interest corresponding to entered telephone number data and associated points of interest. Thus, even if a user does not know telephone numbers of all the associated points of interest, any of the associated points of interest can be set as destinations. Also, even if the telephone number data is a representative number shared with a plurality of associated points of interest, a desired point of interest can be set as a destination.

### BRIEF DESCRIPTION OF THE DRAWINGS

FIG. 1 a block diagram showing an example of the structure of a navigation apparatus using a destination search device according to an embodiment of the present invention;

FIG. 2 shows an example of a telephone number database of the destination search device according to the embodiment;

FIGS. 3A to 3C show examples of display screens of the destination search device according to the embodiment;

FIGS. 4A to 4C show examples of a telephone number database of the destination search device according to modifications; and

FIG. 5 is a flowchart showing an operation of the destination search device and a destination search method according to the embodiment.

### DETAILED DESCRIPTION OF THE DRAWINGS AND THE PRESENTLY PREFERRED EMBODIMENTS

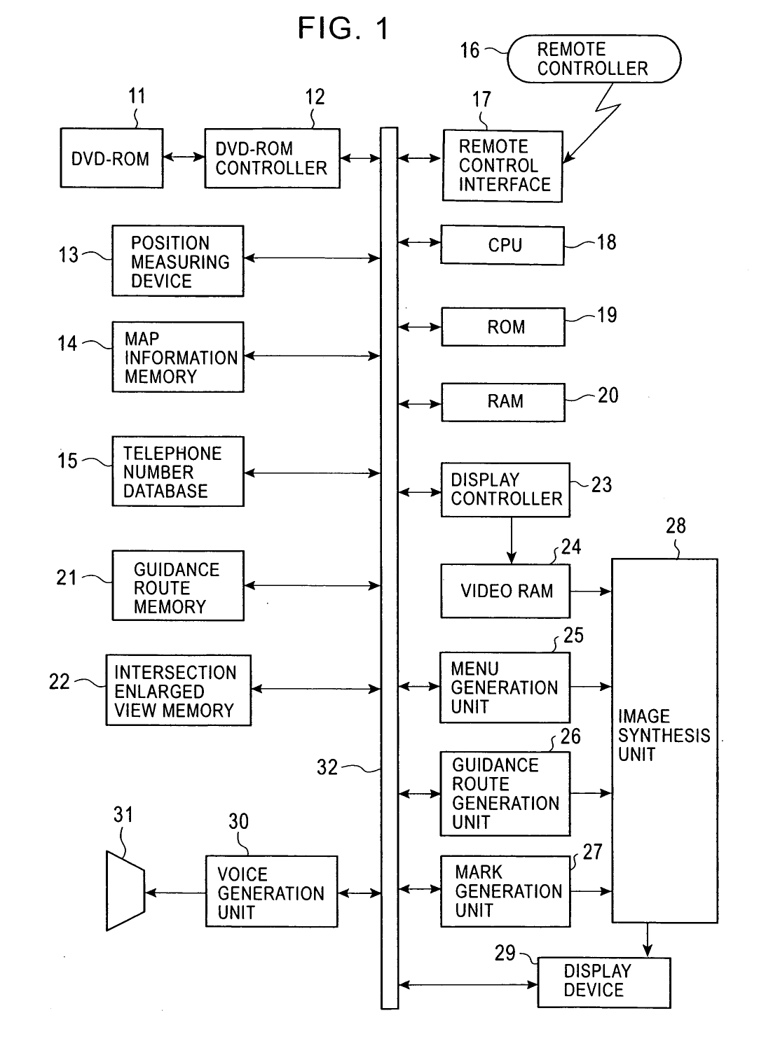

Embodiments of the present invention will be described with reference to the drawings. FIG. 1 is a block diagram showing an example of the general structure of an in-vehicle navigation apparatus using a destination search device according to an embodiment of the present invention. Referring to FIG. 1, a map recording medium, such as a digital versatile disk-read only memory (DVD-ROM) 11, stores various types of map data necessary for map display, route guidance, and the like. Although the DVD-ROM 11 is used as a recording medium for storing the map data, other storage media, such as a compact disk (CD)-ROM or a hard disk, may be used instead of the DVD-ROM 11. A DVD-ROM controller 12 controls reading of the map data from the DVD-ROM 11.

The map data recorded in the DVD-ROM 11 includes position data corresponding to various points. Some pieces of the position data are stored in association with corresponding telephone number data and point of interest (POI) name data. In this case, the position data, the telephone number data, and the POI name data are associated with each other in a 1:1:1 relationship.

A position measuring device 13 determines the current position of a vehicle. The position measuring device 13 includes a self-contained navigation sensor, a GPS receiver, a position calculation central processing unit (CPU), and the like. The self-contained navigation sensor includes a vehicle speed sensor (distance sensor) for detecting a moving distance of the vehicle by outputting a pulse for every predetermined traveling distance and an angular velocity sensor (relative bearing sensor), such as a vibrating gyroscope or the like, for detecting a rotation angle (moving direction) of the vehicle. The self-contained navigation sensor detects relative position and direction of the vehicle using the speed sensor and the angular velocity sensor.

The position calculation CPU calculates absolute current position (estimated position) and direction of the vehicle on the basis of data on the relative position and direction of the vehicle that is provided by the self-contained navigation sensor. Also, the GPS receiver receives electric waves sent from a plurality of GPS satellites via a GPS antenna, and calculates absolute position and direction of the vehicle by performing three-dimensional positioning or two-dimensional positioning. (The vehicle direction is calculated based on the current position of the vehicle and a position of the vehicle a sampling time ΔT in advance.)

A map information memory 14 temporarily stores the map data read from the DVD-ROM 11 under the control of the DVD-ROM controller 12. In other words, the DVD-ROM controller 12 receives information on the current position of the vehicle from the position measuring device 13 and provides an instruction to read map data of a predetermined area including the current position of the vehicle. Thus, map data (including position data of various points, POI name data representing names of POIs, and telephone number data corresponding to such data) necessary for map display and search for a guidance route is read from the DVD-ROM 11 to be stored in the map information memory 14.

A telephone number database 15 stores telephone number data. The telephone number database 15 is provided in advance independent from the map data stored in the DVD-ROM 11. The map information memory 14 corresponds to a first storage unit, and the telephone number database 15 corresponds to a second storage unit. Also, the map information memory 14 and the telephone number database 15 together correspond to a storage unit.

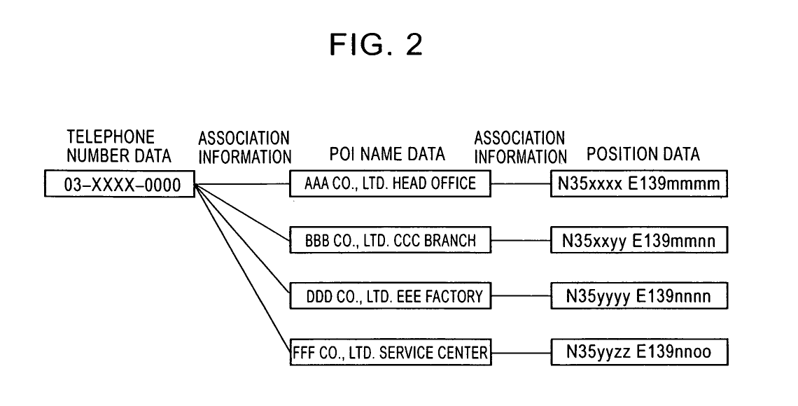

FIG. 2 shows an example of data stored in the telephone number database 15 according to this embodiment. The telephone number database 15 includes telephone number data, a plurality of pieces of POI name data representing the names of POIs corresponding to the telephone number data, and a plurality of pieces of position data representing the positions of the POIs. Also, the telephone number database 15 includes association information representing a relationship in which the plurality of pieces of POI name data is associated with the plurality of pieces of position data in a 1:1 relationship and in which a single piece of telephone number data is associated with the plurality of pieces of POI name data in a 1:m (m is an integer of 2 or more) relationship.

A remote controller 16 (corresponding to a telephone number input unit) includes various operation parts, such as buttons, a joystick, and numeral keys for entering numerical values, such as telephone number data, operated by a user of a navigation apparatus to set various types of information, such as a destination for route guidance, and to perform various operations, such as menu selection, a scaling operation, and manual map scrolling. A remote control interface 17 receives an infrared signal corresponding to the operation state from the remote controller 16.

A processor (CPU) 18 controls the entire navigation apparatus. A ROM 19 stores various programs, such as a position data extraction program for extracting position data corresponding to a telephone number and a guidance route search program. A random-access memory (RAM) 20 temporarily stores data obtained in the process of various types of processing and data obtained from the results of the various types of processing. The CPU 18, the ROM 19, and the RAM 20 correspond to a control unit.

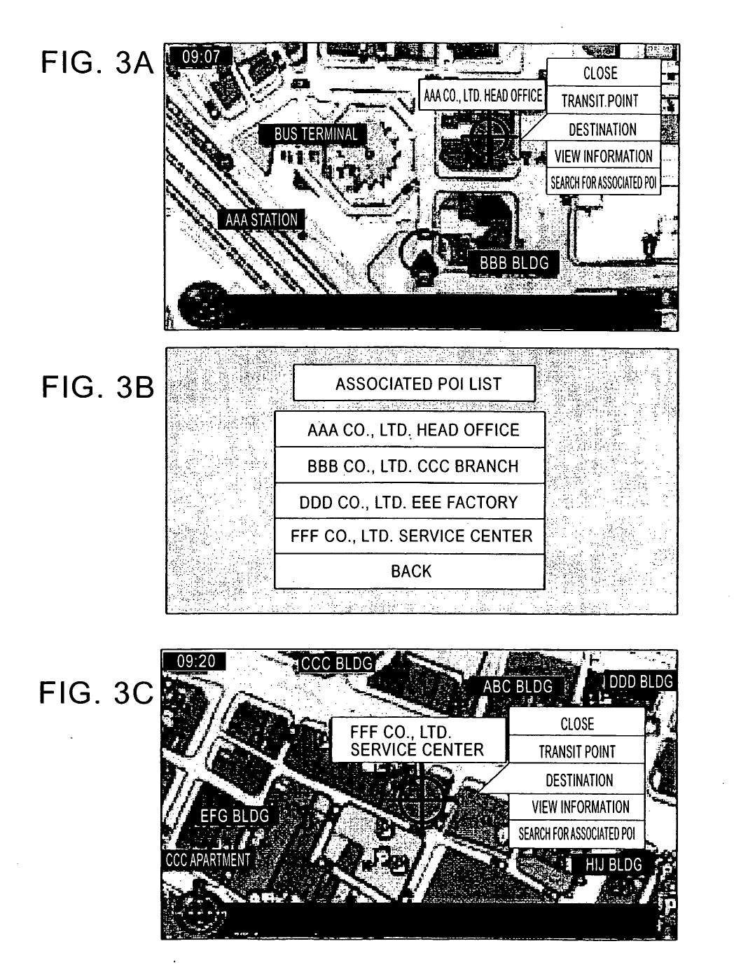

A method for setting a destination will be described with reference to FIGS. 3A to 3C. FIGS. 3A to 3C show examples of a display screen according to this embodiment. In accordance with the position data extraction program stored in the ROM 19, the CPU 18 extracts position data and POI name data corresponding to telephone number data entered by the remote controller 16 and data necessary for displaying a map around the position from the map information memory 14 to be displayed on a screen. Here, a screen shown in FIG. 3A is displayed.

In the screen shown in FIG. 3A, “AAA Co., Ltd. Head Office” is displayed as POI name data corresponding to the entered telephone number data. Also, a selection list is displayed on the screen. If “close” is selected, the display is terminated. If “transit point” is selected, the position is set as a transit point. If “destination” is selected, the position is set as a final destination. If “view information” is selected, information on the position is displayed.

If “search for associated POI” is selected on the screen, it is determined whether or not the telephone number data entered by the remote controller 16 is included in the telephone number database 15. If the entered telephone number data is not included in the telephone number database 15, an error message, such as “No associated POI”, is displayed. If the entered telephone number data is included in the telephone number database 15, it is determined that a plurality of pieces of POI name data and a plurality of pieces of position data corresponding to the telephone number data exist. The CPU 18 extracts the plurality of pieces of POI name data that is associated with the telephone number data by association information from the telephone number database 15 to be displayed on the screen so as to be selectable. Here, a screen shown in FIG. 3B is displayed. A user selects a desired POI from among the plurality of displayed POIs. Here, for example, “FFF CO., Ltd. Service Center” is selected.

Since, as shown in FIG. 2, the POI name data is associated with the corresponding position data by the association information, the CPU 18 extracts the position data of the selected POI, and acquires data necessary for displaying a map around the position from the map information memory 14 to be displayed on the screen. Here, a screen shown in FIG. 3C is displayed. A selection list is also displayed on the screen. If “close” is selected, the display is terminated. If “transit point” is selected, the position is set as a transit point. If “destination” is selected, the position is set as a final destination. If “view information” is selected, information on the position is displayed. If “search for associated POI” is selected on the screen, the display shown in FIG. 3B is displayed again.

If “transit point” or “destination” is selected on the screen shown in FIG. 3A or FIG. 3C, the CPU 18 searches for a guidance route from the current position to the destination that has the lowest cost using the map data stored in the map information memory 14 in accordance with the guidance route search program stored in the ROM 19.

Returning to FIG. 1, a guidance route memory 21 stores data on a guidance route found by the CPU 18. The data on the guidance route includes positions of nodes and intersection identification flags indicating whether or not the nodes are intersections in accordance with the nodes from the current position to the destination.

An intersection enlarged view memory 22 temporarily stores data on enlarged views of all the intersections to be guided through that are located on the guidance route (intersection enlarged views for guiding a vehicle to a destination and images representing a destination and a traveling direction by arrows). The data on the intersection enlarged views is appropriately read from the DVD-ROM 11 under the control of the DVD-ROM controller 12.

A display controller 23 generates map image data necessary for display on a display device 29 in accordance with the map data stored in the map information memory 14. A video RAM 24 temporarily stores the map image data generated by the display controller 23. In other words, the map image data generated by the display controller 23 is temporarily stored in the video RAM 24, and map image data for one display screen is read and provided to an image synthesis unit 28.

A menu generation unit 25 produces a menu image necessary for performing various operations using the remote controller 16. A guidance route generation unit 26 generates data on a guidance route using the processing result of the guidance route search program stored in the guidance route memory 21. In other words, a guidance route included in the map area that is rendered in the video RAM 24 at that time from among the guidance route data stored in the guidance route memory 21 is selectively read and rendered in a superimposed and emphasized manner on the map image using a predetermined color. Also, when the vehicle approaches a range limit of a predetermined distance from an information intersection ahead in the guidance route, the guidance route generation unit 26 produces an image of an information map of the intersection that the vehicle is approaching in accordance with the intersection enlarged view data stored in the intersection enlarged view memory 22.

A mark generation unit 27 produces a vehicle position mark representing a vehicle position after map matching and various landmarks, such as a gas station and a drugstore. Map matching is position correction of the traveling position of the vehicle on a road in the map data using the map data read into the map information memory 14, data on the current position and direction of the vehicle from the GPS receiver measured by the position measuring device 13, and data of the estimated current position and direction of the vehicle from the self-contained navigation sensor.

The image synthesis unit 28 synthesizes and produces various images. In other words, image synthesis is performed by superimposing image data received from the menu generation unit 25, the guidance route generation unit 26, and the mark generation unit 27 on the map image data read by the display controller 23, and the synthesized image is produced on the display device 29. Thus, map information around the vehicle is displayed, together with a vehicle position mark, a destination mark, and the like, on the screen of the display device 29. Also, together with the guidance route displayed on the map, an intersection enlarged view is displayed when the vehicle is approaching near an intersection.

A voice generation unit 30 generates voice information regarding an intersection, voice operation guidance, and the like. A speaker 31 externally produces the voice information generated by the voice generation unit 30. A bus 32 is used for transferring data between the function units described above.

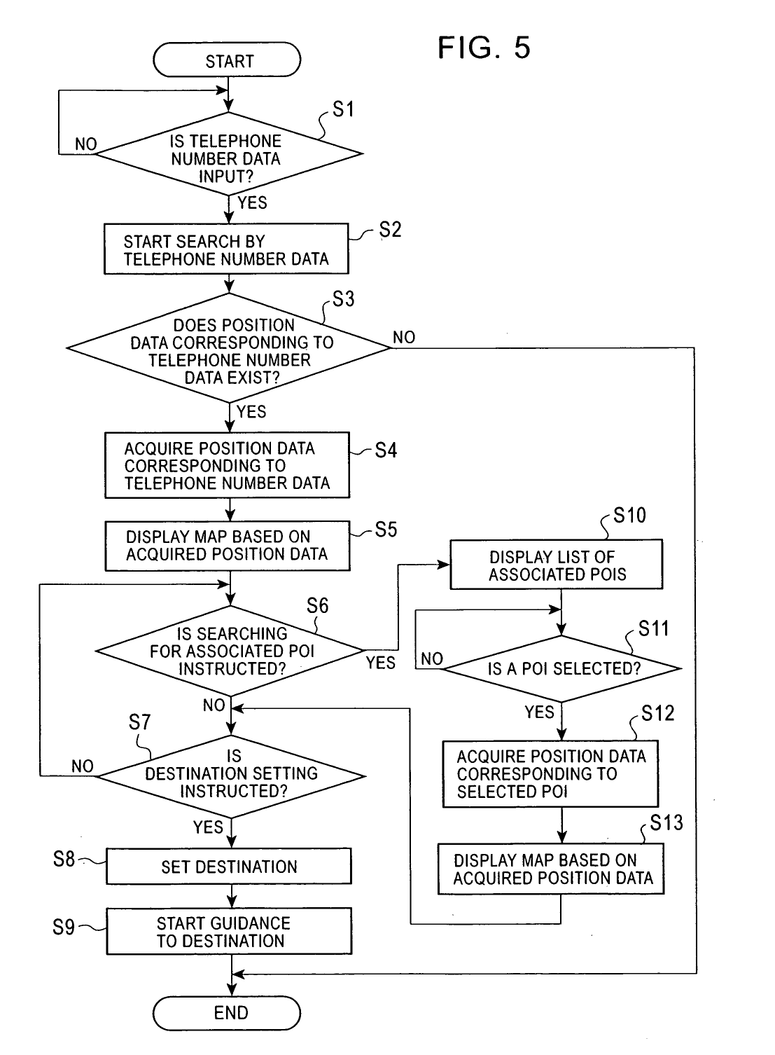

FIG. 5 is a flowchart showing a process performed by the destination search device and a destination search method according to this embodiment. The CPU 18 determines, in accordance with the position data extraction program stored in the ROM 19, whether or not telephone number data is entered by an operation of the remote controller 16 (step S1). If telephone number data is not entered (if the determination in step S1 is NO), the processing in step S1 is repeated until telephone number data is entered.

If telephone number data is entered (if the determination in step S1 is YES), the CPU 18 searches for position data using the map data stored in the map information memory 14 by the telephone number data as a key (step S2). In accordance with a search result, the CPU 18 determines whether or not position data corresponding to the entered telephone number data is included in the map information memory 14 (step S3).

If position data corresponding to the entered telephone number data is not included in the map information memory 14 (if the determination in step S3 is NO), the CPU 18 stops the processing. In contrast, if position data corresponding to the entered telephone number data is included in the map information memory 14 (if the determination in step S3 is YES), the CPU 18 acquires the position data and POI name data corresponding to the telephone number data entered by the remote controller 16 from the map information memory 14 (step S4). Based on the acquired position data, data necessary for displaying a map around the position is extracted from the map information memory 14 and is supplied to the display controller 23. Thus, a map screen shown in FIG. 3A including the point corresponding to the acquired position data is displayed on the display device 29 (step S5).

The CPU 18 determines whether or not searching for an associated POI is instructed (step S6). If searching for an associated POI is not instructed (if the determination in step S6 is NO), the CPU 18 determines whether or not setting the POI shown in FIG. 3A as a destination (including a transit point) is instructed (step S7). If “transit point” or “destination” is selected in the selection list on the screen shown in FIG. 3A (if the determination in step S7 is YES), the POI displayed is set as a destination (step S8). Here, the CPU 18 stores the position data acquired in step S4 in the guidance route memory 21 as destination data.

When an instruction to search for a route is provided by the remote controller 16, the current position of the vehicle is stored in the guidance route memory 21 as departure position data. Then, a traveling route between the departure position and the destination position stored in the guidance route memory 21 is searched for under the conditions designated by the user. For example, a guidance route having the lowest cost under any of the conditions, such as minimum time, shortest route, and minimum charge, can be searched for and set. The CPU 18 begins processing for guiding the vehicle to the destination in accordance with the data regarding the guidance route stored in the guidance route memory 21 (step S9). In contrast, if “transit point” or “destination” is not selected in the selection list on the screen shown in FIG. 3A (if the determination in step S7 is NO), the processing in steps S6 and S7 is repeated.

In contrast, if “search for associated POI” is selected on the screen shown in FIG. 3A (if the determination in step S6 is YES), the CPU 18 determines whether or not the telephone number data entered in step S1 is included in the telephone number database 15. If the entered telephone number data is not included in the telephone number database 15, an error message, such as “No associated POI” is displayed. If the entered telephone number data is included in the telephone number database 15, a plurality of pieces of POI name data corresponding to the telephone number data is acquired from the telephone number database 15. The POI name data is supplied to the menu generation unit 25, and the list shown in FIG. 3B is displayed on the display device 29 (step S10).

The CPU 18 determines whether or not a POI is selected from among the plurality of POIs in the list displayed on the display device 29 (step S11). If a POI is not selected from among the plurality of POIs (if the determination in step S11 is NO), the processing in step S11 is repeated until a POI is selected. In contrast, if a POI is selected from among the plurality of POIs (if the determination in step S11 is YES), the CPU 18 acquires position data corresponding to the POI name data of the selected POI from the telephone number database 15 to be stored in the RAM 20 (step S12). The CPU 18 acquires data necessary for displaying a map around the position from the map information memory 14 in accordance with the acquired position data to be supplied to the display controller 23. Thus, the map screen shown in FIG. 3C including the point corresponding to the acquired position data is displayed on the display device 29 (step S13).

The CPU 18 determines whether or not setting the POI displayed in FIG. 3C as a destination is instructed (step S7). If “transit point” or “destination” is selected in the selection list on the screen shown in FIG. 3C (if the determination in step S7 is YES), the displayed associated POI is set as a destination (step S8). Here, the CPU 18 stores the position data acquired in step S12 in the guidance route memory 21 as destination data.

When an instruction for searching for a route is provided by the remote controller 16, the current position of the vehicle is stored in the guidance route memory 21 as departure position data. Then, a traveling route between the departure position and the destination position stored in the guidance route memory 21 is searched for under the conditions designated by the user. For example, a guidance route having the lowest cost under any of the conditions, such as minimum time, shortest route, and minimum charge, can be searched for and set. The CPU 18 begins processing for guiding the vehicle to the destination in accordance with the data regarding the guidance route stored in the guidance route memory 21 (step S9). In contrast, if “transit point” or “destination” is not selected in the selection list on the screen shown in FIG. 3C (if the determination in step S7 is NO), the processing in steps S6 and S7 is repeated.

As described above, according to this embodiment, a telephone number is associated with a plurality of POIs. Thus, when a destination is searched for using telephone number data, a user can search for a plurality of POIs that correspond to a telephone number as destinations only by memorizing the telephone number. Thus, even if an entered telephone number does not correspond to a desired POI, the desired POI that is stored as an associated POI can be readily set as a destination.

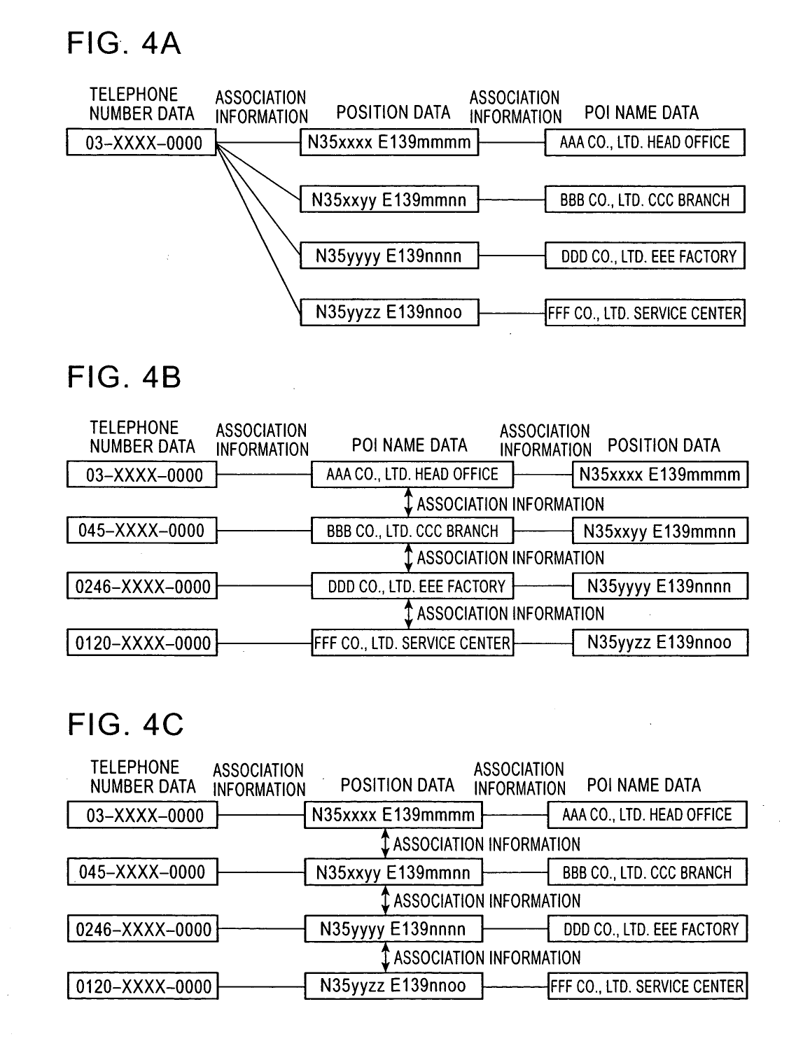

Although telephone number data is directly associated with a plurality of pieces of POI name data in the embodiment described above, the telephone number data may be associated with the plurality of pieces of POI name data via a plurality of pieces of position data, as shown in FIG. 4A. In this case, the telephone number database 15 stores telephone number data, a plurality of pieces of position data representing positions corresponding to the telephone number data, a plurality of pieces of POI name data representing the names of POIs, and association information representing a relationship in which the plurality of pieces of position data is associated with the plurality of pieces of POI name data in a 1:1 relationship and in which a single piece of telephone number data is associated with the plurality of pieces of position data in a 1:m (m is an integer of 2 or more) relationship.

Also, as shown in FIG. 4B, a single piece of telephone number data may be associated with a single piece of POI name data. In this case, for a plurality POIs associated with each other, a plurality of pieces of associated POI name data is associated with each other by association information. Furthermore, as shown in FIG. 4C, a single piece of telephone number data may be associated with a single piece of position data. In this case, for a plurality of POIs associated with each other, a plurality of pieces of associated position data is associated with each other by association information. Accordingly, since a plurality of pieces of POI name data has corresponding telephone number data, when a telephone number is entered, a plurality of associated POIs can be found. Also, since a plurality of pieces of position data has corresponding telephone number data, when a telephone number data is entered, a plurality of associated POIs can be found.

Also, although an example has been explained in which the telephone number database 15 is provided independent from the DVD-ROM 11 (or the map information memory 14); telephone number data, POI name data, and position data having a 1:1:1 relationship is stored in the DVD-ROM 11; and data shown in FIG. 2, FIG. 4A, FIG. 4B, or FIG. 4C is stored in the telephone number database 15, the data is not necessarily stored in different media. The data may be stored in the same medium. For example, all the information may be stored in the DVD-ROM 11. Alternatively, all the information may be stored in the telephone number database 15. The embodiments described above and the case where all the information is stored in the telephone number database 15 have an advantage in that an existing DVD-ROM can be used. In contrast, if all the information is stored in the DVD-ROM 11, the telephone number database 15 is not necessary. Also, only the map information memory 14 is used as a search object and source of data.

In the telephone number database 15 shown in FIG. 4B or FIG. 4C, information other than association information for associating a plurality of pieces of POI name data with each other and association information for associating a plurality of pieces of position data with each other can be stored in the map information memory 14. Thus, only the association information representing association between the plurality of pieces of POI name data and the association information representing association between the plurality of pieces of position data may be stored in the telephone number database 15, and position data and POI name data that correspond to entered telephone number data may be extracted from the map information memory 14. In this case, an existing DVD-ROM may be used. Also, the volume of data in the telephone number database 15 can be reduced.

The embodiments described above are merely examples of the present invention. The technical scope of the present invention should not be understood to be limited by the embodiments described above. Various changes and modifications can be made to the present invention without departing from the spirit and scope of the invention.

1. A destination search device for searching for a destination on the basis of entered telephone number data, comprising:
a telephone number input unit for entering a plurality of pieces of telephone number data;
a storage unit for storing the plurality of pieces of telephone number data, a plurality of pieces of point of interest name data representing names of points of interest, and a plurality of pieces of position data representing positions of the points of interest and for storing association information such that the plurality of pieces of point of interest name data is associated with the plurality of pieces of position data in a 1:1 relationship and such that the plurality of pieces of telephone number data is associated with the plurality of pieces of position data or the plurality of pieces of point of interest name data in a 1:n relationship, n representing an integer of 1 or more; and
a control unit, wherein when a plurality of pieces of point of interest name data or a plurality of pieces of position data is associated with a piece of telephone number data entered by the telephone number input unit, the plurality of pieces of point of interest name data that is associated with the piece of telephone number data is acquired from the storage unit and displayed so as to be selectable by a user, and when only a single piece of point of interest name data or only a single piece of position data is associated with the piece of telephone number data entered by the telephone number input unit, one or both of the single piece of point of interest name data and the single piece of position data that are associated with the piece of telephone number data are acquired from the storage unit.

2. The destination search device according to claim 1, wherein:
the association information associates the plurality of pieces of telephone number data, the plurality of pieces of point of interest name data, and the plurality of pieces of position data in a 1:1:1 relationship; and
the association information associates n pieces of associated point of interest name data with each other.

3. The destination search device according to claim 2, wherein the control unit displays a map using position data corresponding to point of interest name data selected by a user from the plurality of pieces of point of interest name data displayed so as to be selectable or the single piece of position data corresponding to the piece of telephone number data entered by the telephone number input unit.

4. The destination search device according to claim 1, wherein:
the association information associates the plurality of pieces of telephone number data, the plurality of pieces of point of interest name data, and the plurality of pieces of position data in a 1:1:1 relationship; and
the association information associates n pieces of associated position data with each other.

5. The destination search device according to claim 4, wherein the control unit displays a map using position data corresponding to point of interest name data selected from the plurality of pieces of point of interest name data displayed so as to be selectable or the single piece of position data corresponding to the piece of telephone number data entered by the telephone number input unit.

6. The destination search device according to claim 1, wherein the storage unit includes:
a first storage unit for associating and storing the plurality of pieces of telephone number data, the plurality of pieces of point of interest name data, and the plurality of pieces of position data in a 1:1:1 relationship; and
a second storage unit for associating and storing the plurality of pieces of point of interest name data and the plurality of pieces of position data in a 1:1 relationship and for associating and storing a plurality of pieces of associated point of interest name data with a piece of telephone number data.

7. The destination search device according to claim 1, wherein the storage unit includes:
a first storage unit for associating and storing the plurality of pieces of telephone number data, the plurality of pieces of point of interest name data, and the plurality of pieces of position data in a 1:1:1 relationship; and
a second storage unit for storing association information for associating a plurality of pieces of associated point of interest name data with each other.

8. The destination search device according to claim 6, wherein the control unit displays a map using position data corresponding to point of interest name data selected by a user from the plurality of pieces of point of interest name data displayed so as to be selectable or the single piece of position data corresponding to the piece of telephone number data entered by the telephone number input unit.

9. The destination search device according to claim 7, wherein the control unit displays a map using position data corresponding to point of interest name data selected by a user from the plurality of pieces of point of interest name data displayed so as to be selectable or the single piece of position data corresponding to the piece of telephone number data entered by the telephone number input unit.

10. The destination search device according to claim 1, wherein the storage unit includes:
a first storage unit for associating and storing the plurality of pieces of telephone number data, the plurality of pieces of point of interest name data, and the plurality of pieces of position data in a 1:1:1 relationship; and
a second storage unit for associating and storing the plurality of pieces of point of interest name data and the plurality of pieces of position data in a 1:1 relationship and for associating and storing a plurality of pieces of associated position data with a piece of telephone number data.

11. The destination search device according to claim 1, wherein the storage unit includes:
a first storage unit for associating and storing the plurality of pieces of telephone number data, the plurality of pieces of point of interest name data, and the plurality of pieces of position data in a 1:1:1 relationship; and
a second storage unit for storing association information for associating a plurality of pieces of associated position data with each other.

12. The destination search device according to claim 10, wherein the control unit displays a map using position data corresponding to point of interest name data selected by a user from the plurality of pieces of point of interest name data displayed so as to be selectable or the single piece of position data corresponding to the piece of telephone number data entered by the telephone number input unit.

13. The destination search device according to claim 11, wherein the control unit displays a map using position data corresponding to point of interest name data selected by a user from the plurality of pieces of point of interest name data displayed so as to be selectable or the single piece of position data corresponding to the piece of telephone number data entered by the telephone number input unit.

14. The destination search device according to claim 1, wherein the control unit displays a map using position data corresponding to point of interest name data selected by a user from the plurality of pieces of point of interest name data displayed so as to be selectable or the single piece of position data corresponding to the piece of telephone number data entered by the telephone number input unit.

15. A destination search method, executed by a computer, for searching for a destination on the basis of entered telephone number data, comprising:
receiving an input of the telephone number data;
determining whether or not a plurality of pieces of point of interest name data representing names of points of interest that correspond to the received telephone number data is included in a storage unit;
acquiring the plurality of pieces of point of interest name data from the storage unit and displaying the plurality of pieces of point of interest name data so as to be selectable by a user when it is determined that the plurality of pieces of point of interest name data that correspond to the received telephone number data exists; and
acquiring from the storage unit only a single piece of point of interest name data that corresponds to the received telephone number data and displaying the single piece of point of interest name data when it is determined that only the single piece of point of interest name data corresponds to the received telephone number data.

16. The destination search method according to claim 15, further comprising displaying a map using position data corresponding to point of interest name data selected by a user from the plurality of pieces of point of interest name data displayed or position data corresponding to the single piece of point of interest name data acquired.

17. A destination search method, executed by a computer, for searching for a destination on the basis of entered telephone number data, comprising:
receiving an input of the telephone number data;
determining whether or not a plurality of pieces of position data representing positions of points of interest that correspond to the received telephone number data is included in a storage unit;
acquiring from the storage unit a plurality of pieces of point of interest name data representing names of the points of interest that correspond to the plurality of pieces of position data and displaying the plurality of pieces of point of interest name data so as to be selectable by a user when it is determined that the plurality of pieces of position data that correspond to the received telephone number data exists; and
acquiring from the storage unit a single piece of point of interest name data corresponding to a single piece of position data and displaying the single piece of point of interest name data when it is determined that only the single piece of position data corresponds to the received telephone number data.

18. The destination search method according to claim 17, further comprising displaying a map using position data corresponding to point of interest name data selected by a user from the plurality of pieces of point of interest name data displayed or the single piece of position data acquired.
